(19) United States
(12) Patent Application Publication
(10) Pub. No.: US 2004/0130162 A1
(43) Pub. Date: Jul. 8, 2004

(54) Adjustable latch

(75) Inventors: Lan-Kun Don, Chiayi City (TW); Po-Yang Chen, Chiayi City (TW); Rong-Faa Wu, Chiayi County (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Tung Lung Metal Industry Co., Ltd.

(21) Appl. No.: 10/743,503

(22) Filed: Dec. 22, 2003

(30) Foreign Application Priority Data
Dec. 27, 2002 (TW) 091221407

(51) Int. Cl. E05C 1/00

(52) U.S. Cl. 292/1.5

(57) ABSTRACT

The present invention relates to an adjustable latch, having a half-round transmitting member for cooperation with the configuration of the link, the first plate and the second plate. The present invention advantageously provides flexibility in different installation distances and allows the insertion of the transmitting member to rotate and drive the bolt head to be retracted.

In addition, the present invention can be used with either a cylindrical faceplate member or a rectangular faceplate member and installed therewith easily.

### FIELD OF THE INVENTION

The present invention relates to an adjustable latch, which is particularly capable of eliminating the disadvantages of transmission interference between the transmitting portions of the first and second plates of the lock. The present invention can be flexibly used with either a cylindrical faceplate member or a rectangular faceplate member.

### BACKGROUND OF THE INVENTION

U.S. Pat. No. 4,711,477 (see FIGS. 1 and 2), assigned to TONG LUNG METAL INDUSTRY CO., LTD., discloses a duplex latch bolt mechanism for use with a handle assembly 40 comprising a curved transmitting member 42 having a curved cross section. The curved transmitting member 42 can cooperate with the configuration of the extracting teeth 277 and 278 so as to allow the bolt retracting member 27 to be shifted within a predetermined installation distance, such that the transmitting member can be rotated to actuate the bolt retracting member and accordingly perform the unlocking operation.

FIG. 2 is an explanatory drawing of FIG. 1, in which a conventional half-round transmitting member 50 (similar to transmitting member 42) is engaged with the rear extracting teeth 278 in the rearward clearing spaces 315 and 325. The broken lines show the turning tacks of the half-round transmitting member 50 and the tacks of the rear extracting teeth 278 engaged and moved by said transmitting member 50. Referring to FIGS. 1 and 2 at the same time, generally speaking, the transmitting member 50 must be configured in a way that the bolt head 21 can be completely retracted, and the ratio of distances along bottom side 283 of lever 28 from the extension member than from the retracting member 27 is 2:1. This means that the bolt head 21 can be fully retracted if the retracting member 27 is moved rearward for simply about 6 mm. In other words, before reaching position c, the transmitting member 50 cannot move the retracting member 27 to achieve the purpose of retracting by actuating bolt head 21. Therefore, because the conventional transmitting member 50 of FIG. 2 cannot match the spaces between the extracting teeth 277 and 278, it will be blocked by the front extracting teeth 277 when it is rotated to position b—thus will not able to go forward any more. Therefore, the rotation of the transmitting member 50 of the handle assembly 40 cannot fully retract the bolt head 21.

### SUMMARY OF THE INVENTION

To overcome the above problem, the present invention improves the above conventional structures and eliminates the interference between the transmitting member and the transmitting portion (i.e., the front extraction teeth). Nevertheless, because the adjustable latch of the present invention does not change the shape of the transmitting member, it can be used with the transmitting member 50 of similar handle assembly 40 widely available in the market.

The principle objective of the present invention is to provide an adjustable latch which eliminates the interference between the transmitting member and the transmitting portion without changing the shape of the transmitting member.

The second objective of the present invention is to provide an adjustable latch in which the front faceplate member of the latch faceplate can be either a cylindrical faceplate member or a rectangular faceplate member.

To achieve the above objectives, the present invention discloses an adjustable latch, comprising:

a housing, said housing including a bolt head at an inner part of a front end thereof, said bolt head being moveable from a forward extending position to a rearward retracting position under the actuation of a latch actuating mechanism; said latch actuating mechanism including:

a link arranged in the housing, said link including a slot extending in the middle of a rear end thereof for a predetermined length and a pair of elongated pieces on each side of the slot, each of said elongated pieces formed with a transmitting portion and a recess on a predetermined position thereon; and

a first plate and a second plate arranged adjacent the elongated pieces on each side of said slot of said link, wherein each of said first plate and said second plate is formed with a transmitting portion and an engaging tab, wherein the transmitting portion and engaging tab of the first plate respectively oppose those of the second plate, and wherein the respective engaging tabs of said first and second plates are engageable with said recesses on the link such that the first and second plates are slidable with respect to the link for a small distance, and that the transmitting portions of the link are axially spaced apart from the transmitting portions of the first and second plates along an axial direction, whereby the lock-latch mechanism can be selectively actuated by a transmitting member of a handle assembly to achieve the operation of the latch.

According to a further embodiment of the present invention, an adjustable latch comprises:

a housing, said housing including a bolt head at an inner part of a front end thereof, said bolt head being moveable from a forward extending position to a rearward retracting position under the actuation of a latch actuating mechanism;

at least one projection extending transversely from a front end of the housing;

a cylindrical faceplate member removably assembled to the front end of the housing;

an elongated slot extending on the inner wall of the cylindrical faceplate member and generally parallel to the axial direction of the latch;

a transverse slot for engagement with the projections of the housing, said transverse slot extending on the wall of the cylindrical faceplate member and communicating with said elongated slot;

a thru hole formed in the cylindrical faceplate member for receiving the bolt head.

### BRIEF DESCRIPTION OF THE DRAWINGS

FIG. 1 is an exploded view showing a conventional adjustable latch bolt mechanism;

FIG. 2 is a schematic view illustrating part of the coupling structure of the adjustable latch bolt mechanism of FIG. 1;

FIG. 3 is an exploded view showing a preferred embodiment of the adjustable latch of the present invention;

FIG. 4 is a partial cross-sectional view of the preferred embodiment of the present invention, used in an installation distance of 60 mm;

FIG. 5 is a partial cross-sectional view of the preferred embodiment of the present invention, used in an installation distance of 70 mm;

FIG. 6 is a perspective view showing the coupling relationship between the adjustable latch of the present invention and a cylindrical faceplate member;

FIG. 7 is a perspective view showing the adjustable latch of the present invention coupling to a ring; and

FIG. 8 is a perspective view showing the adjustable latch of the present invention coupling to a rectangular faceplate member and an auxiliary faceplate member.

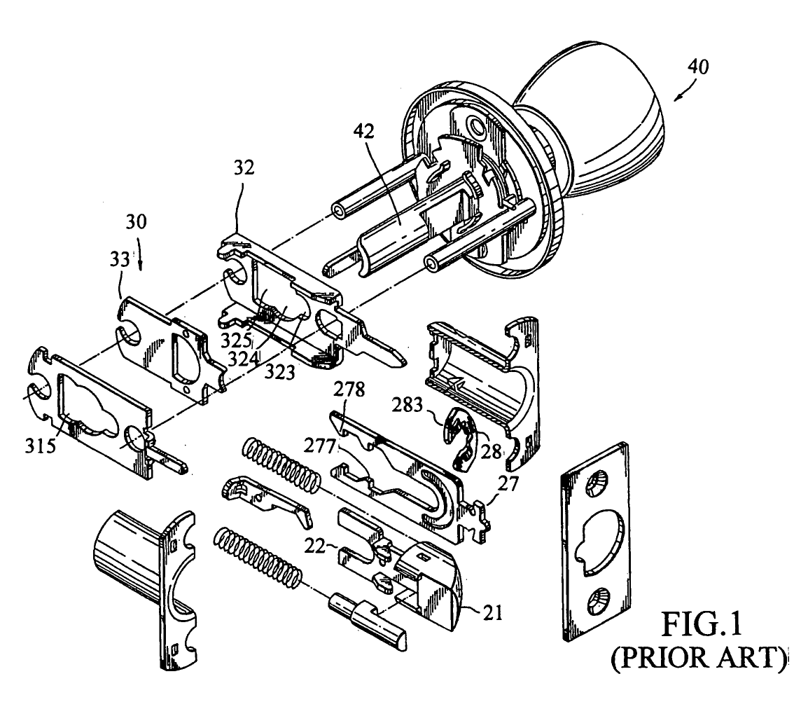

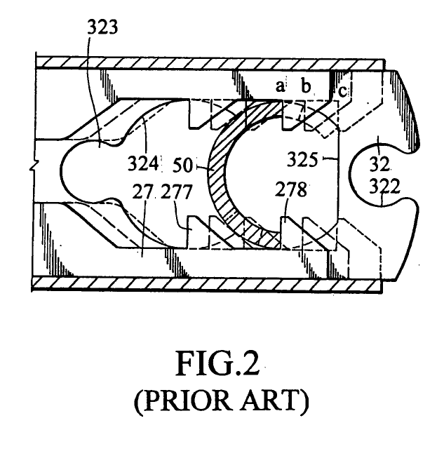

### DETAILED DESCRIPTION OF PREFERRED EMBODIMENT

An adjustable latch according to a preferred embodiment of the present invention is explained in detail below along with the accompanying drawings.

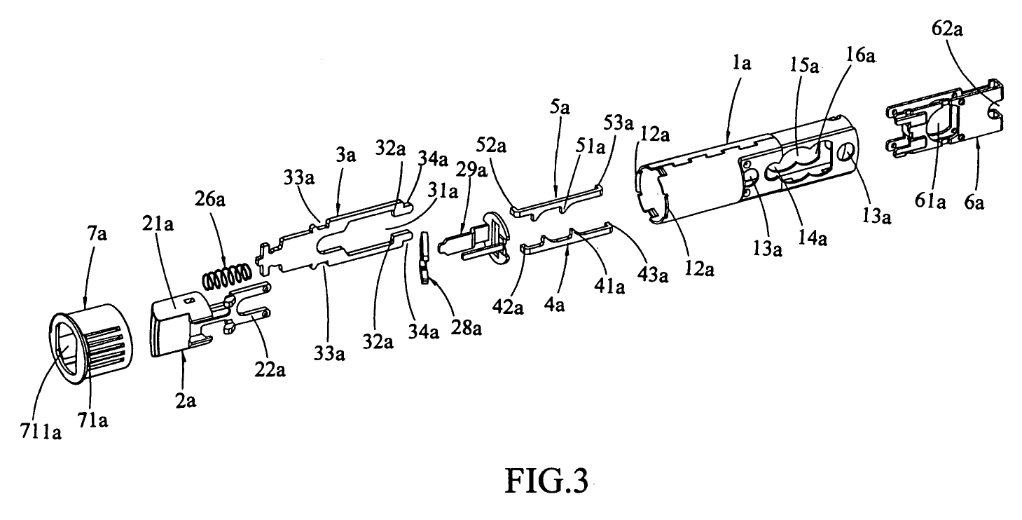

As shown in FIG. 3, the adjustable latch of the present invention comprises a housing (1a), a cylindrical faceplate member (7a), a lock-latch transmitting system and a latch actuating mechanism, wherein:

The housing (1a) preferably consists of a plate body curved into shape. The front end of the housing (1a) can accommodate the latch transmitting mechanism, while the rear end thereof can receive a latch actuating mechanism. At least one projection (12a) (but preferably a pair of projections (12a)) extending transversely from the front end of the housing (1a) engages with a corresponding L-shaped slot (or slots). The housing (1a) further includes front positioning apertures (13a), a rear positioning aperture (14a) and an opening (15a).

The latch actuating mechanism comprises a link (3a), a first plate (4a) and a second plate (5a).

The link (3a) is assembled in the housing (1a) with its front end connected to the latch transmitting mechanism. The link (3a) includes a slot (31a) extending in the middle of a rear end thereof for a predetermined length and a pair of elongated pieces on each side of the slot, wherein each of said elongated pieces is formed with a transmitting portion (32a), a recess (33a) on a predetermined position thereon, and a positioning member (34a).

The first plate (4a) and the second plate (5a) are preferably arranged adjacent to the elongated pieces on each side of the slot (31a) of the link (3a). The first plate (4a) is formed with a transmitting portion (41a), an engaging tab (42a) and a locating portion (43a), and the second plate (5a) is formed with a transmitting portion (51a), an engaging tab (52a) and a locating portion (53a), wherein the transmitting portion (41a), engaging tab (42a) and locating portion (43a) of the first plate (4a) respectively oppose the transmitting portion (51a), engaging tab (52a) and locating portion (53a) of the second plate (5a). The locating portions (43a, 53a) can be located in a way for engaging with respective positioning members (34a) on the elongated pieces of the link (3a). Accordingly, the respective engaging tabs (42a, 52a) of the first and second plates (4a, 5a) are adapted to be engaged with recesses (33a) on the link (3a). The axial distances of the recesses (33a) of the link (3a) are respectively larger than those of the corresponding engaging tabs (42a, 52a) of the first and second plates (4a, 5a), such that the first and second plates (4a, 5a) are slidable with respect to the link (3a) for a small distance. The transmitting portions (32a) of the link (3a) are axially spaced apart from the transmitting portions (41a, 51a) of the first and second plates (4a, 5a) along an axial direction, such that the above latch actuating mechanism can be selectively actuated by a half-round transmitting member (50) of a handle assembly to achieve the operation of the latch.

The adjustable latch further comprises an adjusting member (6a) having a generally U-shaped cross section, a central opening (61a) and an auxiliary positioning aperture (62a). The first plate (4a), the second plate (5a) and the elongated pieces on each side of the slot (31a) of the link (3a) are inserted into the U-shaped cross section of the adjusting member (6a). The above components are together assembled into the housing (1a).

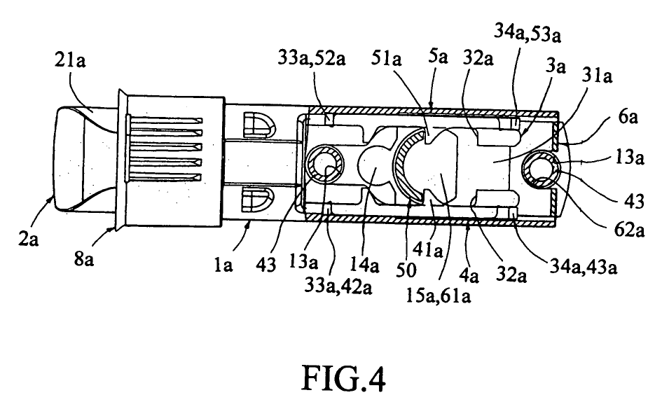

As shown in FIG. 4, the opening (61a) of the adjusting member (6a) is aligned with the opening (15a) of the housing (1a). This arrangement is used when the present invention is used as an installation distance of 60 mm. When assembling, the half-round transmitting member (50) of the handle assembly extends through openings (15a, 61a) and engages with transmitting portions (41a, 51a) of the first and second plates (4a, 5a), and the support nuts (43) of the handle assembly extend through the front positioning apertures (13a) and the auxiliary positioning aperture (62a). Normally, the bolt head (21a) is in an out-extending state. When the half-round transmitting member (50) is rotated by rotating the handle of the handle assembly in a clockwise direction, the transmitting portion (51a) of the second plate (5a) will drive the link (3a) to move the latch transmitting mechanism so as to retract the bolt head (21a). When the half-round transmitting member (50) is rotated by rotating the handle at the handle assembly in a counterclockwise direction, the transmitting portion (41a) of the first plate (4a) will drive the link (3a) to move the latch transmitting mechanism so as to retract the bolt head (21a).

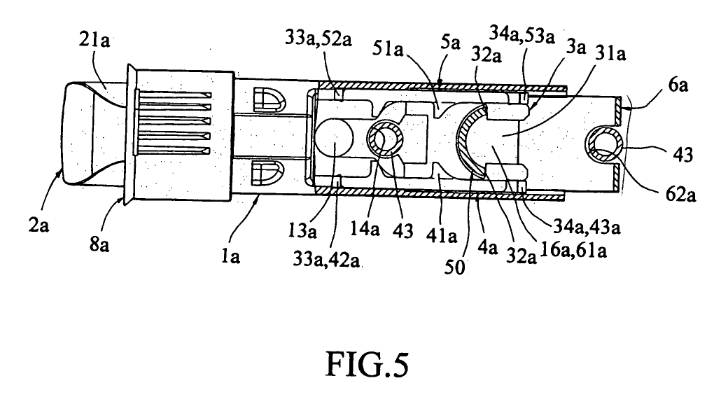

As particularly shown in FIG. 5, if the adjusting member (6a) is moved in a way that the opening (61a) is aligned with opening (16a) of the housing (1a), the present invention is used as an installation distance of 70 mm. When assembling, the half-round transmitting member (50) of the handle assembly extends through openings (16a, 61a) and engages with transmitting portions (32a) of the link (3a), and the support nuts (43) of the handle assembly extends through the rear positioning aperture (14a) and the auxiliary positioning aperture (62a). When the half-round transmitting member (50) is rotated by rotating the handle of the handle assembly in a clockwise or counterclockwise direction, the transmitting portions (32a) of the link (3a) will drive the latch transmitting mechanism so as to retract the bolt head (21a). During this operation, there is no transmission interference even if the half-round transmitting member (50) contacts the transmitting portion (41a) of the first plate (4a) or the transmitting portion (51a) of the second plate (5a). This is particularly because that since the first and second plates (4a, 5a) are slidable with respect to the link (3a) for a small distance, there would be no transmission interference as the half-round transmitting member (50) will never contact the transmitting portion (41a) of the first plate (4a) or the transmitting portion (51a) of the second plate (5a). Because there is no transmission interference, the rotation of the half-round transmitting member (50) will not be blocked or interfered. This ensures that the rotation of the half-round transmitting member (50) can axially move the link (3a) which in turn drives the latch transmitting mechanism to retract the bolt head (21a) to a predetermined retraction position.

The present invention can be flexibly used with either a cylindrical faceplate member or a rectangular faceplate member. The adjustable latch of the present invention can accommodate a wider use than the conventional art. For example, the present invention provides flexibility in the faceplate-assembling structure as stated below.

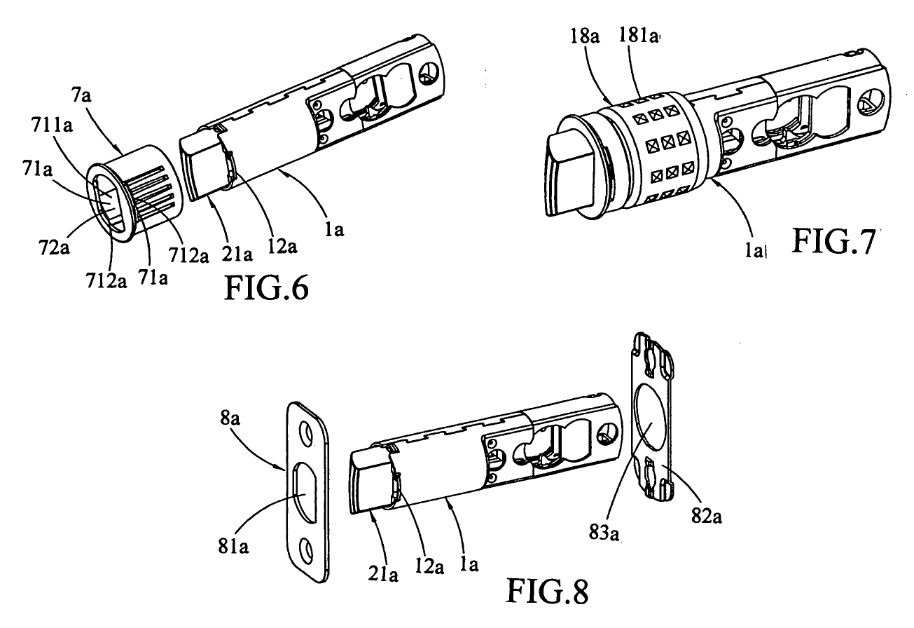

As shown in FIG. 6, the housing (1a) is coupled to a cylindrical faceplate member (7a). The cylindrical faceplate member (7a) has at least one L-shaped slot (71a) corresponding to the at least one projection (12a) formed at the front end of the housing (1a). Each of the L-shaped slots (71a) consists of an elongated slot (711a) and a transverse slot (712a) communicating with each other, wherein the elongated slot (711a) extends on the inner wall and generally parallel to the axial direction of the latch, and the transverse slot (712a) extends on the wall. In assembling, the at least one projection (12a) of the housing (1a) is aligned with the corresponding elongated slot (711a) of the at least one L-shaped slot (71a), and then the front end of the housing (1a) is inserted axially into the cylindrical faceplate member (7a) in a way that the at least one projection (12a) is flush with the at least one transverse slot (712a). Thereafter, the cylindrical faceplate member (7a) is rotated for an angle with respect to the housing (1a) so as to align the bolt head (21a) with the thru hole or latch-receiving hole (72a) of the cylindrical faceplate member (7a). The bolt head (21a) can be extended through the cylindrical faceplate member (7a) for a predetermined length under the action of the internal spring (26a) of the housing (1a) and then engages the cylindrical faceplate member (7a).

To disassemble the cylindrical faceplate (7a) from the housing (1a), the bolt head (21a) is first pressed toward the housing (1a) in a way to allow the cylindrical faceplate member (7a) to rotate with respect to the housing (1a) for an angle, such that the at least one elongated slot (711a) of the cylindrical faceplate member (7a) can be aligned with corresponding projection (12a) of the housing (1a) so as to allow the cylindrical faceplate member (7a) to be detached from the housing (1a). The cylindrical faceplate member (7a) can be replaced by another type of faceplate member.

Furthermore, as shown in FIG. 6, the outer wall of the cylindrical faceplate member (7a) can be provided with a couple of axially extending ribs with which the cylindrical faceplate members (7a) can engage with the corresponding inner wall of a door (not shown) for installation. FIG. 7 illustrates a modified version of the embodiment of FIG. 6, in which the cylindrical faceplate member (7a) does not contain ribs on its outer wall, but instead is coupled to a ring (18a) having a couple of projections (181a) which allows the cylindrical faceplate members (7a) to engage with the inner wall of a door. In addition, the ring (18a) also provides the advantage of easy installation of the handle assembly because it is rotatable with respect to the housing (1a).

FIG. 8 illustrates an alternative embodiment in which a rectangular faceplate member (8a) and an auxiliary faceplate member (82a) are used. Upon installation onto a door, the housing (1a) is inserted into the thru hole (83a) of the auxiliary face plate member (82a), and the bolt head (21a) in the housing (1a) is inserted through the thru hole (81a) of the rectangular faceplate member (8a), with the projections (12a) positioned between the rectangular faceplate member (8a) and the auxiliary faceplate member (82a).

All of the above are used to illustrate the preferred embodiments of the present invention, and are not intended for limiting the present invention. Any equivalent embodiment of other simple variations made according to the structure, features, spirit and the claims of the present invention should all be included within the scope of the following claims.

1. An adjustable latch, comprising:
a housing, including a bolt head at an inner part of a front end thereof, said bolt head being moveable from a forward extending position to a rearward retracting position when being actuated by latch actuating mechanism; said latch actuating mechanism including:
a link arranged in the housing, said link including a slot having a predetermined length and formed at a middle portion of a rear end thereof; a pair of elongated pieces formed on both sides of the slot respectively, each of said elongated pieces formed with a transmitting portion and a recess at a predetermined position thereon; and
a first plate and a second plate respectively arranged adjacent to the two elongated pieces on the both sides of said slot of said link, said first plate being formed with a transmitting portion and an engaging tab, said second plate being formed with a transmitting portion and an engaging tab, wherein the engaging tab of said first plate and the engaging tab of said second plate are adapted to respectively engage with said two recesses formed on the link, such that the first and second plates are slidable with respect to the link for a small distance, and that the transmitting portions of the link are spaced apart from the transmitting portions of the first and second plates along an axial direction, whereby the lock-latch mechanism can be selectively actuated by a half-round transmitting member of a handle assembly to achieve the operation of the latch.

2. The adjustable latch as claimed in claim 1, wherein an axial distance of each of the recesses of the link is greater than an axial distance of each of the corresponding engaging tabs of the first and second plates.

3. The adjustable latch as claimed in claim 1, wherein the link further comprises positioning members disposed on the elongated pieces on the slots thereof, and said first plate and second plate comprising locating portions for respectively engaging with said positioning members.

4. The adjustable latch as claimed in claim 1, further comprising an adjusting member, said adjusting member having a generally U-shaped cross section and being slidable back and forth in the housing.

5. The adjustable latch as claimed in claim 1, wherein the housing is provided with a faceplate member at a front end thereof.

6. The adjustable latch as claimed in claim 5, wherein the faceplate member has a cylindrical shape.

7. The adjustable latch as claimed in claim 5, wherein the faceplate member has a rectangular shape.

8. The adjustable latch as claimed in claim 6, wherein the front end of the housing comprises at least one projection for engaging with a corresponding slot or L-shaped slot formed on the cylindrical member.

9. An adjustable latch, comprising:
a housing, including a bolt head at an inner part of a front end thereof, said bolt head being moveable from a forward extending position to a rearward retracting position when being actuated by latch actuating mechanism;
at least one projection extending transversely from the front end of the housing;
a cylindrical faceplate member removably assembled to the front end of the housing;
an elongated slot extending on an inner wall of the cylindrical faceplate member and generally parallel to an axial direction of the latch;
a transverse slot for being engaged with the projections of the housing, said transverse slot extending on the wall of the cylindrical faceplate member and communicating with said elongated slot;
a thru hole formed in the cylindrical faceplate member for receiving the bolt head.
